(19) United States
(12) Patent Application Publication
(10) Pub. No.: US 2015/0191665 A1
(43) Pub. Date: Jul. 9, 2015

(54) FUEL SYNTHESIZING METHOD AND FUEL SYNTHESIZING APPARATUS

(71) Applicants: Mitsuhiro Matsuzawa, Tokyo (JP); Shigenori Togashi, Tokyo (JP)

(72) Inventors: Mitsuhiro Matsuzawa, Tokyo (JP); Shigenori Togashi, Tokyo (JP)

(73) Assignee: Hitachi, Ltd., Chiyoda-ku, Tokyo (JP)

(21) Appl. No.: 14/405,790

(22) PCT Filed: Jun. 7, 2012
(86) PCT No.: PCT/JP2012/064632

§ 371 Date: Dec. 5, 2014

(51) Int. Cl. C10L 1/02; B01J 19/12

(52) U.S. Cl. CPC C10L 1/026; B01J 19/126; C10L 2200/0476; C10L 2270/026; C10L 2290/36; C10L 2290/24; B01J 2219/0877; B01J 2219/0871; B01J 2219/1215

(57) ABSTRACT

A purpose of the present invention is to enhance the efficiency of utilization of microwave energy in the synthesis of fuel by increasing the contact area between multiple raw materials and concentrating a catalyst in the neighborhood of the interface at which the raw materials come into contact with each other. This fuel synthesizing method includes: mixing an alcohol and a catalyst to prepare a catalyst-containing raw material fluid and then preparing a mixed solution by mixing the catalyst-containing raw material fluid and fat; and irradiating the mixed solution with microwaves to synthesize a fatty acid ester in which the alcohol is bound with a fatty acid constituting the fat.

### TECHNICAL FIELD

The present invention relates to a fuel synthesizing method and a fuel synthesizing apparatus.

### BACKGROUND ART

Light oil, heavy oil, and other oils, which are prepared by refining a crude oil as underground resources at a refinery, emit carbon dioxide in the processes of refining from a crude oil and burning the oils as a fuel, whereby the amount of carbon dioxide on the ground is increased. The increase in carbon dioxide is thought to be one of the factors contributing to global warming. For this reason, a biodiesel fuel derived from plant-based fat is attracting attention in terms of the prevention of global warming.

A biodiesel fuel is a fuel prepared mainly from fat (triglyceride) derived from plants or animals, and is an alternative to a liquid fuel for operating a diesel engine. A main component of the fat is triglyceride. In the case of plant-derived fat, plants having absorbed atmospheric carbon dioxide synthesize fat in vivo by photosynthesis using solar energy, and the fat stored in vivo becomes a main raw material.

Even if a biodiesel fuel mainly based on fat prepared by absorbing atmospheric carbon dioxide is burned as a fuel, emitted carbon dioxide is absorbed in plants again. Accordingly, carbon dioxide is circulated, and carbon dioxide on the earth is thought not to increase. This concept is called carbon-neutral and has recently received much attention.

A biodiesel fuel can be prepared with various manufacturing methods. One of the methods is to synthesize fatty acid methyl ester (FAME), which is the main component of a biodiesel fuel, by ester exchange reaction between plants-based fat and methanol in the presence of a catalyst.

For example, PTL 1 describes a method for esterifying a fatty acid derived from plants or animals in the presence of anionic liquid. According to PTL 1, the ionic liquid acts as a solvent and/or a catalyst.

### CITATION LIST

### Patent Literature

PTL 1: JP 2008-533232 W

### SUMMARY OF INVENTION

### Technical Problem

In the method described in PTL 1, fat, an alcohol, and an ionic liquid, used as raw materials, are mixed by an agitator of a conventional magnetic agitation device. The interface between the fat and the alcohol, which are not mixed with each other, does not increase, and therefore, there has been room for improvement on an issue that reaction requires long time. This issue is also associated with the fact that it is hard for an ionic liquid to sufficiently come into contact with the neighborhood of the interface between the fat and the alcohol, which are raw materials.

Regarding a heating method, since a conventional heater heating method heats a whole reaction vessel, energy efficiency becomes low. A heating method using microwave also has an issue that microwave energy is not easily absorbed into a water-free reaction liquid.

A purpose of the present invention is to enhance the efficiency of utilization of microwave energy in the synthesis of fuel by increasing the contact area between multiple raw materials and concentrating a catalyst in the neighborhood of the interface at which the raw materials come into contact with each other.

### Solution to Problem

This fuel synthesizing method includes: mixing an alcohol and a catalyst to prepare a catalyst-containing raw material fluid and then preparing a mixed solution by mixing the catalyst-containing raw material fluid and fat; and irradiating the mixed solution with microwaves to synthesize a fatty acid ester in which the alcohol is bound with a fatty acid constituting the fat.

### Advantageous Effects of Invention

According to the present invention, it is possible to disperse micro-droplets of an alcohol including a catalyst, in a liquid fat, to enhance the efficiency of utilization of microwave energy, and to accelerate reaction.

### BRIEF DESCRIPTION OF DRAWINGS

FIG. 1 is a schematic configuration view of a fuel synthesizing apparatus of an example.

FIG. 2 is a schematic view showing fat and methanol, which are mixed.

FIG. 3 is a schematic view showing fat, methanol, and an ionic liquid, which are mixed.

FIG. 4 is a schematic view showing fat, methanol, and a solid catalyst, which are mixed.

FIG. 5 is a schematic configuration view of the fuel synthesizing apparatus of the example.

FIG. 6 is a schematic configuration view of the fuel synthesizing apparatus of the example.

FIG. 7 is a schematic configuration view of the fuel synthesizing apparatus of the example.

FIG. 8 is an exploded perspective view of a mixer of the example.

### DESCRIPTION OF EMBODIMENTS

The present invention relates to a fuel synthesizing method and a fuel synthesizing apparatus. Examples of biodiesel fuel synthesis will be described below. The examples are applicable to other fuel synthesis.

A fuel synthesizing method and a fuel synthesizing apparatus according to an embodiment of the present invention will be described below.

The fuel synthesizing method includes mixing an alcohol and a catalyst to prepare a catalyst-containing raw material fluid and then preparing a mixed solution by mixing the catalyst-containing raw material fluid and fat; and irradiating the mixed solution with microwaves to synthesize a fatty acid ester in which the alcohol is bound with a fatty acid constituting the fat.

In the fuel synthesizing method, the mixed solution is preferably obtained by dispersing liquid droplets of the catalyst-containing raw material fluid in the fat.

In the fuel synthesizing method, a catalyst is preferably an ionic liquid.

In the fuel synthesizing method, a relative dielectric loss factor of the ionic liquid is preferably higher than that of methanol.

In the fuel synthesizing method, the catalyst is preferably a solid.

In the fuel synthesizing method, preferably, the mixed solution is irradiated with the microwaves after being pressurized to a standard atmospheric pressure or higher, and the mixed solution is heated at equal to or higher than a standard boiling point.

In the fuel synthesizing method, the mixed solution, which has been irradiated with the microwaves, is preferably irradiated with the microwaves at least one more time.

In the fuel synthesizing method, preferably, the mixed solution is irradiated with the microwaves in a state that the introduction of the mixed solution is stopped and the mixed solution is retained, and then the mixed solution is irradiated with the microwaves again in a state that the mixed solution is replaced, the introduction of the mixed solution is stopped, and the mixed solution is retained.

The fuel synthesizing apparatus includes: a mixing unit configured to prepare a mixed solution by mixing fat and a catalyst-containing raw material fluid including an alcohol and a catalyst; and a microwave irradiation unit configured to irradiate the mixed solution with microwaves, wherein the microwave irradiation unit has a function of synthesizing a fatty acid ester in which the alcohol is bound with a fatty acid constituting the fat.

In the fuel synthesizing apparatus, the mixed solution is preferably obtained by dispersing liquid droplets of the catalyst-containing raw material fluid in the fat.

The fuel synthesizing apparatus preferably further includes a premixing unit configured to prepare the catalyst-containing raw material fluid by mixing the alcohol and the catalyst.

The fuel synthesizing apparatus is preferably capable of pressurizing the mixed solution in the microwave irradiation unit.

The fuel synthesizing apparatus preferably further includes a flow channel for circulating the mixed solution, which has passed through the microwave irradiation unit, to the microwave irradiation unit.

In the fuel synthesizing apparatus, the microwave irradiation unit preferably irradiates the mixed solution, which is stopped being introduced and is retained, with microwaves.

Examples will be described below with reference to the drawings.

### Example 1

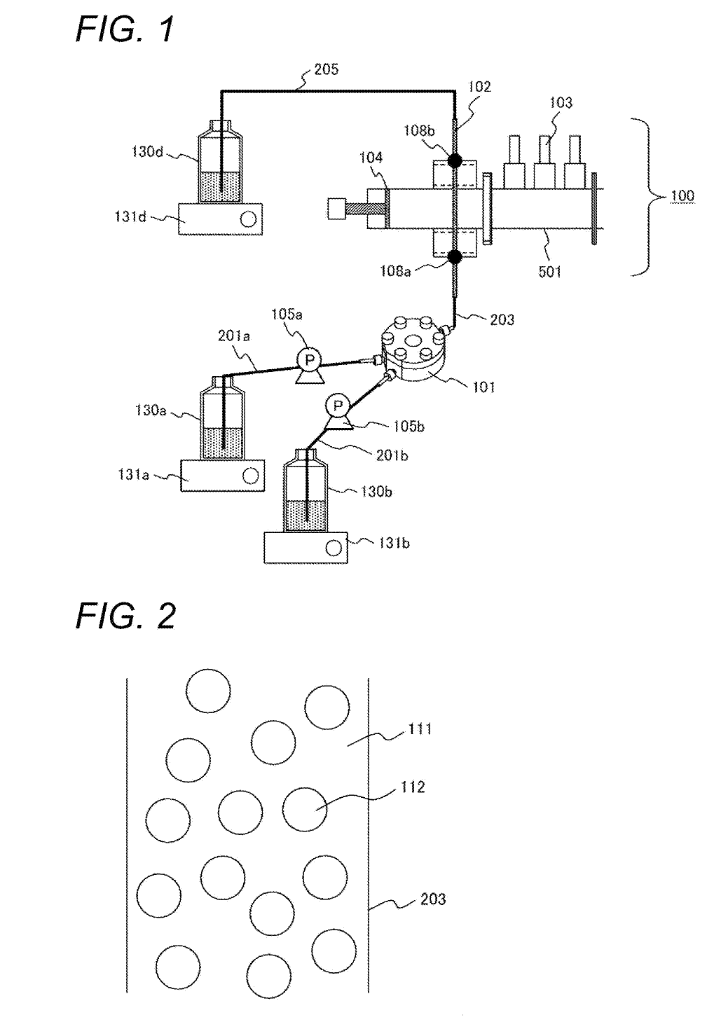

FIG. 1 is a schematic configuration view of a fuel synthesizing apparatus of Example 1.

The fuel synthesizing apparatus shown in FIG. 1 includes a mixer 101 (mixing unit) for mixing multiple chemicals and a microwave irradiation unit 100. The mixer 101 is connected to a raw-material tank 130a through a pipe 201a, and connected to a chemical tank 130b through a pipe 201b. The raw-material tank 130a is for storing fat as a raw material. Also, the chemical tank 130b is for storing a catalyst-containing raw material fluid obtained by mixing a catalyst with methanol as a raw material. At the mixer 101, the fat introduced from the pipe 201a and the catalyst-containing raw material fluid introduced from the pipe 201b are joined and mixed with each other. The width of a flow channel in the mixer 101 (a diameter or a minimum size of the flow channel) is preferably tens to hundreds of micrometers. In this flow channel, micro-droplets of the catalyst-containing raw material fluid are easily dispersed in the fat.

Furthermore, the fat and the catalyst-containing raw material fluid are preferably injected in either flow. This makes it possible to promote agitation and disperse the catalyst-containing raw material fluid.

Also, by using the mixer 101 including the flow channel, the particle size of micro-droplets of the catalyst-containing raw material fluid can be controlled and uniformed.

The microwave irradiation unit 100 includes a microwave generator which is not illustrated, a waveguide 501, a stub tuner 103, a movable short circuit plate 104, and a reaction tube 102. The reaction tube 102 is arranged so as to penetrate through the waveguide 501. The inlet side of the reaction tube 102 and the mixer 101 are coupled with a pipe 203. Also, the outlet side of the reaction tube 102 is coupled with a product liquid tank 130d through a pipe 205. A liquid including a fuel obtained by reaction in the microwave irradiation unit 100 is sent to the product liquid tank 130d through the pipe 205.

The pipe 201a is provided with a liquid feeding pump 105a for feeding the fat in the raw material tank 130a. The pipe 201b is provided with a liquid feeding pump 105b for feeding a catalyst-containing raw material fluid in the chemical tank 130b. The raw material tank 130a, the chemical tank 130b, and the product liquid tank 130d are provided with agitation devices 131a, 131b, and 131d, respectively, to agitate each liquid.

The inlet side and the outlet side of the reaction tube 102 are provided with temperature measuring units 108a and 108b, respectively. As the temperature measuring units 108a and 108b, a thermocouple, an infrared thermometer, and an optical fiber thermometer are available. Among these, the optical fiber thermometer includes a fluorescent material in a temperature sensor, and measures a temperature by irradiating the fluorescent material with excitation light and detecting produced fluorescence with a sensor. For this reason, the optical fiber thermometer is especially desirable because it can measure a temperature accurately without being affected by a microwave even while being subjected to microwave radiation or without affecting electromagnetic field distribution. An optical fiber thermometer, T/Guard with a T1 sensor manufactured by Neoptix, was used in Example 1.

The fat as a raw material is introduced into the mixer 101 from the raw material tank 130a by the liquid feeding pump 105a. Also, the catalyst-containing raw material fluid, which is a mixture of the methanol and the catalyst, is introduced into the mixer 101 from the chemical tank 130b by the liquid feeding pump 105b. The fat and the catalyst-containing raw material fluid are mixed in the mixer 101, and a mixed solution, in which micro-droplets of the methanol included in the catalyst-containing raw material fluid are dispersed in the fat, is obtained.

FIG. 2 schematically shows a microscopic state of the mixed solution.

As shown in FIG. 2, micro-droplets of methanol 112 are dispersed in fat 111 in the pipe 203.

Then, the mixed solution is introduced into the reaction tube 102 shown in FIG. 1, subjected to microwave radiation, heated, and undergoes a reaction. An outlet temperature of the mixed solution after the reaction is measured at the temperature measuring unit 108b shown in FIG. 1, and an output of the microwaves is adjusted so as to become a desired temperature. The catalyst is preferably an alkali catalyst, such as sodium hydroxide and potassium hydroxide. If the alkali catalyst is used, the catalyst dissolves and is dispersed in the methanol 112. More specifically, the methanol 112 is a catalyst-containing raw material fluid.

According to the structure of Example 1, since an interface between the fat 111 and the methanol 112 increases, the reaction can be accelerated.

When a mixed solution of the fat 111 and the methanol 112 is irradiated with microwaves, the methanol absorbs a significant portion of the microwaves, and the mixed solution is heated. This is because a relative dielectric loss factor at a temperature of 25° C. of a microwave at a frequency of 2.45 GHz is 0.1 or less in the case of the fat, and is approximately 13 in the case of the methanol, and a heating value proportional to the relative dielectric loss factor of the methanol becomes higher than that of the fat. Therefore, it is possible to heat only the methanol without heating the fat. Accordingly, it is not necessary to heat the whole mixed solution, and energy consumption can be reduced.

Also, fatty acid methyl ester is a main component of a fuel component (biodiesel) produced by reaction of the mixed solution. The fatty acid methyl ester tends to dissolve in the fat 111, and moves to the fat 111 (fat phase). The fat 111 has a small relative dielectric loss factor, and hardly absorbs microwaves. Accordingly, the fat 111 is hardly heated by the microwaves, and the temperature thereof is lower than the temperature of the interface, in which reaction occurs.

According to Example 1, therefore, unnecessary heating of a product material can be reduced, and the decomposition of the product material can be suppressed.

The microwave irradiation unit 100 will be herein described in detail.

Microwaves, generated from a microwave generator, enter the movable short circuit plate 104, and is reflected thereon. Due to interference between incident waves and reflected waves, standing waves are produced in the microwave irradiation unit 100. Microwave energy absorbed in a material is proportional to the square of an electric field intensity. Accordingly, if the reaction tube 102 is provided at a portion where the electric field intensity of the produced standing waves is large, microwaves can be efficiently absorbed into the reaction liquid flowing in the reaction tube 102.

Also, the stub tuner 103 is provided to adjust impedance in the microwave irradiation unit 100. As long as adjustment of the impedance in the microwave irradiation unit 100 is possible, an EH tuner, for example, can be used instead of the stub tuner 103.

Furthermore, the movable short circuit plate 104 is movable in the traveling direction of microwaves. By adjusting the position of the movable short circuit plate 104, the position of standing waves can be delicately adjusted, and microwaves can be efficiently absorbed into a reaction liquid flowing in the reaction tube 102.

The reaction tube 102 is preferably configured with materials, which are permeable to microwaves, and have a small relative dielectric loss factor; more specifically, for example, glass, resin, and ceramics. A straight tube, a helical tube, and a multiple helical tube are preferred as the shape thereof, but the shape is not limited thereto. Although a rectangular waveguide 501 is used in Example 1, the waveguide 501 may be cylindrical or may have other shape. As microwave transmission means, a transmission device, such as a coaxial cable, may be used instead of the waveguide.

Even if the reaction tube 102 is put in a simple microwave oven, microwaves irregularly reflect in the microwave oven, and a reaction liquid cannot efficiently absorb the microwaves. The above structure makes it possible to intensively irradiate the reaction liquid with microwaves, and to efficiently heat the reaction liquid.

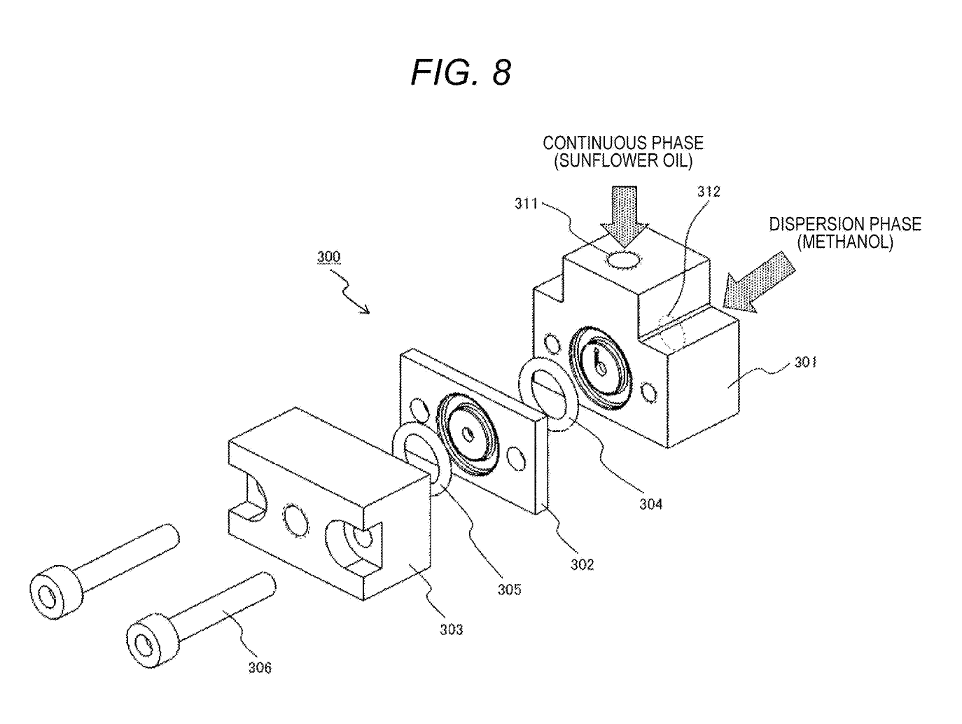

FIG. 8 shows an example of a mixer.

In FIG. 8, a mixer 300 is formed by joining together with an introduction unit 301, a dispersion unit 302, and a discharge unit 303. A packing 304 is sandwiched between the introduction unit 301 and the dispersion unit 302. A packing 305 is sandwiched between the dispersion unit 302 and the discharge unit 303. These are fixed by tightening with a bolt 306 to prevent liquid leakage.

The introduction unit 301 is provided with an inlet for fat 311 and an inlet for a catalyst-containing raw material fluid 312. Fat and a catalyst-containing raw material fluid, which have flowed in through the inlets, meet and become a mixed solution at the dispersion unit 302, and flow out from the discharge unit 303.

In Example 1, an inner diameter of a flow channel of the introduction unit 301 is 2.5 mm.

The dispersion unit 302 is provided with an orifice having an inner diameter of 0.10 mm and a length of 0.30 mm. A liquid flows from a narrow flow channel (the orifice) to a wide flow channel. As a flow channel is rapidly widened, mixing of the fat and the catalyst-containing raw material fluid is accelerated, and a desired mixed solution (dispersion liquid) can be obtained.

In FIG. 8, the fat is a sunflower oil and a continuous phase. The catalyst-containing raw material fluid is a dispersion phase where a catalyst is dispersed in methanol.

### Example 2

The structure of the fuel synthesizing apparatus in Example 2 is similar to that in Example 1. They differ in that anionic liquid is used as a catalyst in Example 2. Accordingly, in Example 2, the chemical tank 130b shown in FIG. 1 stores a catalyst-containing raw material fluid obtained by mixing methanol as a raw material and an ionic liquid functioning as a catalyst. An alkali catalyst such as sodium hydroxide and potassium hydroxide may be further added to the catalyst-containing raw material fluid.

The ionic liquid herein means liquid salt, and narrowly means a compound, which is liquid at ordinary temperature and pressure, and contains cation and anion.

The ionic liquid is classified into pyridine series, alicyclic amine series, and aliphatic amine series, depending on the type of cation. Specific examples of cation include 1,3-dialkylimidazolium ion and 1,3,5-trialkylimidazolium ion having an imidazole ring, and 1-alkylpyridinium ion having a pyridine ring. Specific examples of anion include tetrafluoroborate (BF₄⁻) and hexafluorophosphate (PF₆⁻).

The ionic liquid has various excellent characteristics, such as non-volatility, non-combustibility and stability. There is a thought that an ionic liquid is a new surfactant.

For example, an imidazolium-type ionic liquid has a chemical structure similar to that of a cationic surfactant when a long-chain alkyl group is used as one of the alkyl groups bound to an imidazolium ring. Accordingly, when the ionic liquid is dissolved in water, a molecular assembly similar to a surfactant is formed. Examples of the ionic liquid include 1-butyl-3-methylimidazolium tetrafluoroborate (abbreviated as C₄mimBF₄, hereinafter abbreviated in a similar manner), C₈mimCl, C₈mimI, C₄mimC₈SO₄, C₉mimBr, C₁₀mimBr, C₁₀mimCl, C₁₂mimBr, C₁₂mimCl, C₁₂mimBF₄, C₁₄mimBr, and C₁₆mimBr. When an alkyl chain becomes C₈ or more, a micelle tends to be formed as is the case with conventional surfactants.

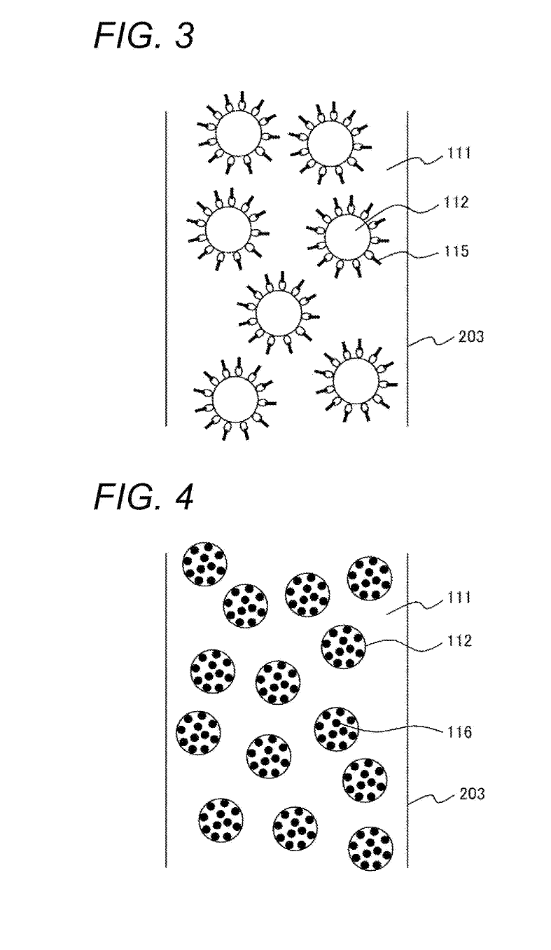

FIG. 3 shows a microscopic state of a mixed solution produced by passing an ionic liquid having the above characteristics through the mixer 101 shown in FIG. 1, when such an ionic liquid is selected and used.

In FIG. 3, micro-droplets of methanol 112 are produced in fat 111 flowing in a pipe 203. Molecules of the ionic liquid 115 are regularly arranged on an interface between the fat 111 and the methanol 112, and a reversed micelle is formed.

Regarding heating by microwaves, Example 2 is similar to Example 1. The microwaves are largely absorbed into the methanol 112 and heated. Accordingly, only the methanol 112 can be heated without heating the fat 111.

It is more efficient if a relative dielectric loss factor of the ionic liquid 115 is higher than that of the methanol 112.

In this case, as shown in FIG. 3, the ionic liquid 115 intensively existing on the interface between the fat 111 and the methanol 112 tends to absorb microwaves in comparison with the methanol 112, and thus the interface is locally heated. Therefore, only a surrounding area of the ionic liquid 115, where reaction is desired, comes to have a high temperature. Accordingly, energy supply for reaction can be reduced.

A mixed solution after heating includes a fuel component (biodiesel) produced, glycerin as a by-product, remaining methanol, and an ionic liquid. However, the biodiesel and the ionic liquid are not mixed together, and can be easily separated. Also, water and methanol can be easily separated by a method including distillation. Therefore, the ionic liquid can be easily separated from other materials.

According to Example 2, recycling of the ionic liquid becomes possible, and the amount of waste can be reduced.

### Example 3

The structure of the fuel synthesizing apparatus in Example 3 is similar to that in Example 1. They differ in that an solid catalyst is used as a catalyst in Example 3. Accordingly, in Example 3, a catalyst-containing raw material fluid, which is obtained by mixing methanol as a raw material with a solid catalyst, is stored in the chemical tank 130b shown in FIG. 1.

The solid catalyst is mixed with methanol in advance. Also, during storage, the catalyst-containing raw material fluid is constantly or intermittently agitated by the agitation device 131b shown in FIG. 1 so that the solid catalyst is uniformly dispersed in methanol. A magnetic agitation device and an ultrasonic agitation device are available as the agitation device 131b as long as those can agitate the catalyst-containing raw material fluid.

FIG. 4 shows, in the case where a solid catalyst is used, a microscopic state of a mixed solution, which is produced by passing the solid catalyst through the mixer 101 shown in FIG. 1.

In FIG. 4, micro-droplets of methanol 112 are produced in fat 111 flowing in a pipe 203. A solid catalyst 116 is included in the micro-droplets of the methanol 112. Examples of the solid catalyst include, but are not limited to, lime, clay, metallic oxide, calcium oxide, calcium hydroxide, anion exchange resin, and zirconia sulfate.

The amount of heat generation of a material heated by microwaves is proportional to a relative dielectric loss factor of the material, as described above, and also proportional to an electric conductivity and a magnetic loss factor of the material. The solid catalyst 116 has a high relative dielectric loss factor, electric conductivity, or magnetic loss factor, and tends to absorb more microwaves than the methanol 112. If the solid catalyst 116 is used as a catalyst, the solid catalyst 116 can be selectively heated by microwaves, in a mixed solution including the fat 111, the methanol 112, and the solid catalyst 116.

In this case, the solid catalyst 116 is included in micro-droplets of the methanol 112, and always exists in the neighborhood of the interface between the fat 111 and the methanol 112, in which reaction occurs, and is selectively heated by microwaves. For this reason, the neighborhood of the interface between the fat 111 and the methanol 112 locally has a high temperature, and the reaction is accelerated. Furthermore, it is not necessary to heat the whole mixed solution, and thus energy consumption can be reduced.

The mixed solution after reaction includes a fuel component produced (biodiesel), glycerin as a by-product, remaining methanol, and a solid catalyst. The solid catalyst can be easily separated such as by a filter. The separated and recovered solid catalyst can be repetitively used, and the amount of waste can be reduced.

### Example 4

The structure of a fuel synthesizing apparatus in Example 4 is different from that of Example 1 in that methanol and a catalyst are stored in separate tanks.

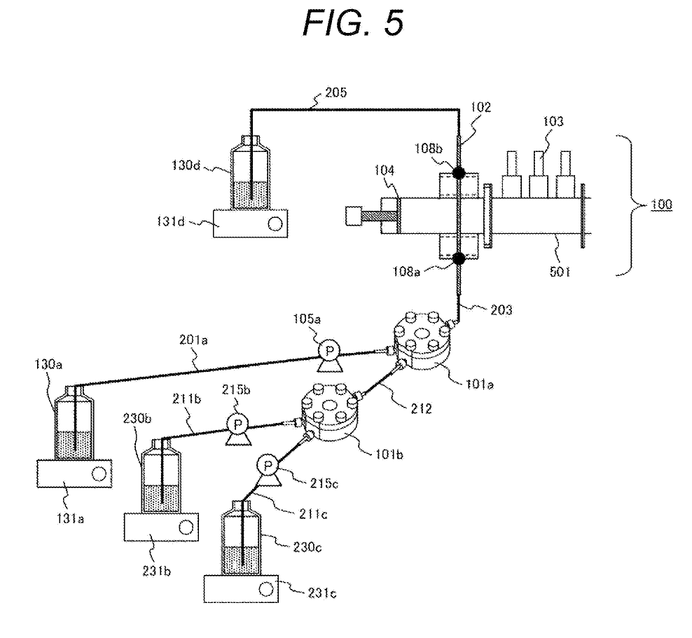

FIG. 5 shows a schematic configuration of the fuel synthesizing apparatus of Example 4. Only points different from Example 1 are described herein by using FIG. 5.

In FIG. 5, a raw material tank 230b for storing methanol as a raw material and a catalyst tank 230c for storing an ionic liquid as a catalyst are separately arranged. The tanks are connected to pipes 211b and 211c, respectively. The pipes 211b and 211c are connected to a mixer 101b. The mixer 101b is connected to a mixer 101a through a pipe 212. The pipes 211b and 211c are provided with liquid feeding pumps 215b and 215c, respectively. The mixer 101b is a premixing unit.

The methanol as a raw material and the ionic liquid as a catalyst are sent to the mixer 101b respectively by the liquid feeding pumps 215b and 215c, and mixed in the mixer 101b to become a catalyst-containing raw material fluid. This catalyst-containing raw material fluid is sent to the mixer 101a and mixed with fat as a raw material to become a mixed solution.

The width of flow channels in the mixers 101a and 101b (a diameter or a minimum size of the flow channel) is preferably tens to hundreds of micrometers.

By using the mixer 101b having such flow channels, the amount of the ionic liquid with respect to the methanol can be controlled. Also, by using the mixer 101a having the flow channel, the particle size of micro-droplets of the catalyst-containing raw material fluid can be controlled.

Furthermore, by using the mixers 101a and 101b in combination, reaction becomes uniform and highly efficient, and a fuel component yield is stabilized.

### Example 5

The structure of a fuel synthesizing apparatus in Example 5 is different from that of Example 4 in that a back pressure valve is provided at the downstream of a reaction tube.

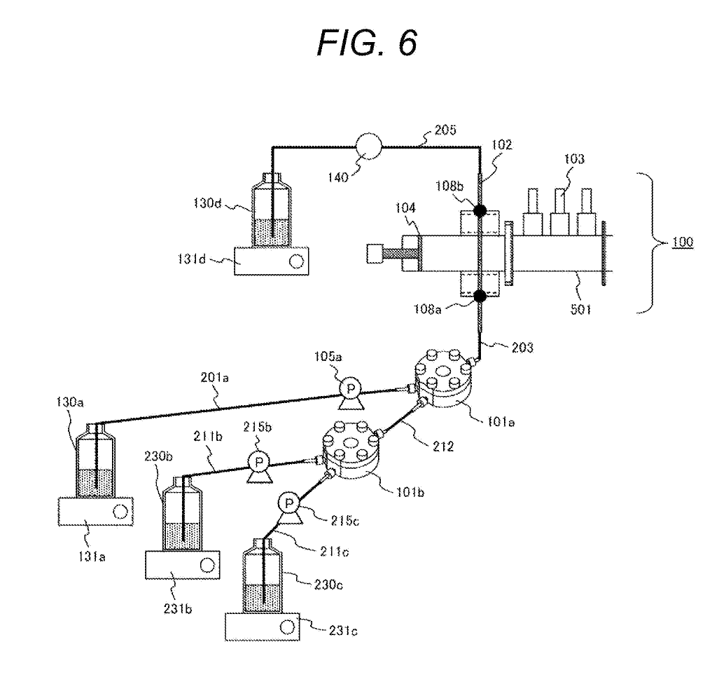

FIG. 6 shows a schematic configuration of the fuel synthesizing apparatus of Example 5. Only points different from Example 4 are described herein by using FIG. 6.

In FIG. 6, a back pressure valve 140 is provided on a pipe 205 at the downstream of a reaction tube 102.

Fat, methanol, and an ionic liquid constituting a mixed solution are pressurized by liquid feeding pumps 105a, 215b, and 215c, respectively, introduced into a mixer 101a, reacted in the reaction tube 102, and sent to a product liquid tank 130d through the pipe 205.

In Example 5, the back pressure valve 140 is provided on the pipe 205, and the upstream of the back pressure valve 140 is pressurized. Therefore, boiling of the mixed solution and a product liquid in the reaction tube 102 is suppressed. Accordingly, a mixed solution can be reacted in a liquid state while maintaining a high temperature.

Among the components constituting the mixed solution, methanol has the lowest boiling point, which is approximately 64° C. When the methanol boils, reaction is significantly suppressed.

As shown in Example 5, by providing the back pressure valve 140 at the downstream of the reaction tube 102, the reaction in a liquid state can be accelerated even at 64° C. or higher, which is a boiling point of methanol.

Usually, the higher the temperature is, the more a chemical reaction rate constant increases, and the reaction is speeded up. In an ester exchange reaction in Example 5, the more the temperature rises, the more the reaction rate constant increases, and the reaction is speeded up. Therefore, the reaction itself can be promoted by providing the back pressure valve 140 on the downstream of the reaction tube 102, as in Example 5.

### Example 6

The structure of a fuel synthesizing apparatus of Example 6 is different from that of Example 1 in that a pipe is provided with a valve, and in that a pipe for circulating a part of the product liquid from a product liquid tank is provided between a mixer and a reaction tube.

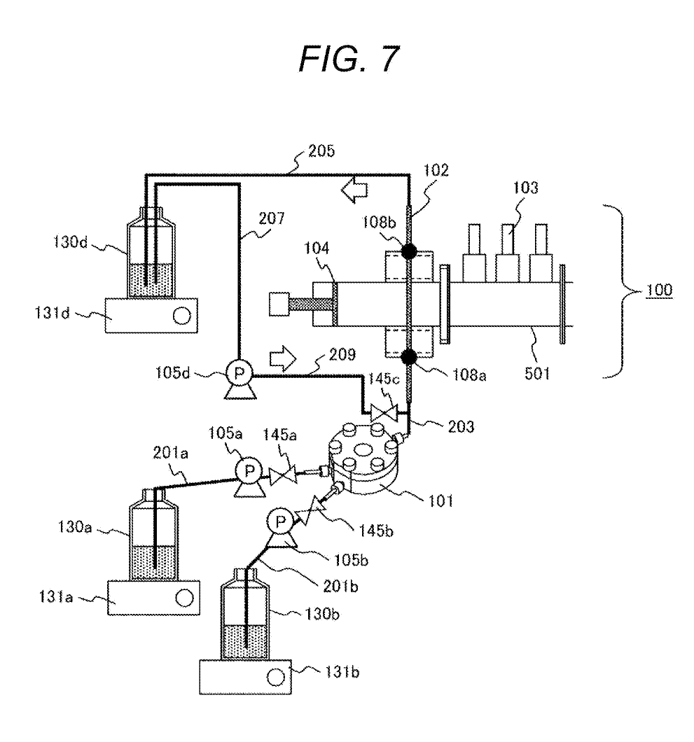

FIG. 7 shows a schematic configuration of the fuel synthesizing apparatus of Example 6. Only points different from Example 1 are described herein by using FIG. 7.

In FIG. 7, pipes 201a and 201b are provided with valves 145a and 145b, respectively. The valves 145a and 145b are provided on the downstream of liquid feeding pumps 105a and 105b, respectively. A pipe 209 is provided between a product liquid tank 130d and a pipe 203 on the upstream of a reaction tube 102. A liquid feeding pump 105d is installed on the pipe 209 so as to pressurize a product liquid and circulate the liquid to the pipe 203. A valve 145c is provided on the pipe 209. A catalyst applicable in Example 6 is an alkali catalyst such as sodium hydroxide and potassium hydroxide, an ionic liquid and, a solid catalyst.

The apparatus is initially operated under the condition that the valves 145a and 145b are opened and the valve 145c is closed, as the product liquid has not been stored in the product liquid tank 130d. When the product liquid is stored in the product liquid tank 130d, the valve 145c is opened, the valves 145a and 145b are closed, and the liquid feeding pump 105d is operated. Accordingly, the product liquid stored in the product liquid tank 130d is again introduced into the reaction tube 102, and subjected to microwave irradiation.

The product liquid stored in the product liquid tank 130d includes unreacted components, and therefore, the reaction is further promoted by microwave irradiation. The product liquid having a high fuel component concentration returns to the product liquid tank 130d and is circulated.

The valves 145a and 145b may be opened, and the liquid feeding pumps 105a and 105b may be kept operating. In this case, a mixed solution, which is obtained by mixing new fat, methanol and catalyst in a mixer 101, and a product liquid flowing from the product liquid tank 130d and having undergone reaction once or more are mixed and introduced into the reaction tube 102.

According to the structure, the mixed solution, which has been heated by microwaves in the reaction tube 102, is circulated and repetitively heated in the reaction tube 102 by microwaves. Accordingly, even if reaction is not completed by heating once, the reaction can be certainly completed, and a product biodiesel can be obtained at a high yield.

### Example 7

Although the structure of the fuel synthesizing apparatus in Example 7 is similar to that in the example described above, it differs in that, after introducing a mixed solution into a reaction tube by operating the apparatus, additional introduction is stopped, and the mixed solution is retained in the reaction tube and irradiated with microwaves for a long time to promote reaction.

The description will be given below by using FIG. 1.

First, a mixed solution is introduced into the reaction tube 102 by operating the liquid feeding pumps 105a and 105b, and the mixed solution is irradiated with microwaves by the microwave irradiation unit 100 to heat the mixed solution. With the reaction tube 102 filled with the mixed solution, the liquid feeding pumps 105a and 105b are stopped for a certain period of time, and microwave irradiation is continued to further heat the mixed solution. In this case, the temperature measuring units 108a and 108b measure the temperature of the mixed solution and adjust microwave output power such that the mixed solution has a desired temperature.

When the desired temperature is reached or a predetermined period of time elapses, the liquid feeding pumps 105a and 105b are again operated to send the heated and reacted mixed solution to the product liquid tank 130d and also to introduce unheated mixed solution into the reaction tube 102. Then, the liquid feeding pumps 105a and 105b are again stopped for a certain period of time, and the mixed solution is irradiated with microwaves to be heated.

As described above, by repetitive start and stop of the liquid feeding pumps 105a and 105b, a heating time is extended, reaction is accelerated and fuel component concentration is increased. During the repetitive start and stop, microwaves may be continuously emitted, or may be emitted only while the liquid feeding pumps 105a and 105b are stopped and a mixed solution is retained in the reaction tube 102.

By the repetitive start and stop, temperature distribution between an inlet and an outlet of the reaction tube 102 can be reduced. Also, by adjusting microwave output power, the temperature of the whole mixed solution in the reaction tube 102 can be increased to a desired temperature and kept constant at that temperature. Accordingly, reaction is certainly accelerated and a desired yield can be obtained.

The mixed solution may be supplied and stopped by opening and closing the valves 145a and 145b shown in FIG. 7.

The above operation is applicable in any of Examples 1 to 6.

An advantageous effect of the invention will be described below.

According to the present invention, micro-droplets of an alcohol can be dispersed in fat. This makes it possible to increase a contact interface area between the fat and the alcohol and accelerate reaction.

Also, in the case where an ionic liquid is used as a catalyst, the alcohol and the ionic liquid are mixed in advance to prepare a catalyst-containing raw material fluid, and then the catalyst-containing raw material fluid and the fat are mixed to disperse micro-droplets of the catalyst-containing raw material fluid in the fat, concentrate the ionic liquid in the neighborhood of the interface between the fat and the catalyst-containing raw material fluid, and accelerate the reaction.

The alcohol has a higher relative dielectric loss factor and tends to absorb more microwave than the fat. Therefore, the alcohol is mainly heated, and reaction is advanced on the interface between the fat and micro-droplets of the catalyst-containing raw material fluid including alcohol. Since the fat hardly absorbs microwaves, and only the alcohol absorbs microwaves and is heated, it is possible to efficiently utilize microwave energy for the reaction without heating the whole mixed solution.

Furthermore, in the case where an ionic liquid, which tends to absorb microwaves compared with alcohol, is selected, when micro-droplets of a catalyst-containing raw material fluid including an alcohol, which is present in fat, and the ionic liquid are irradiated with microwaves, the ionic liquid concentrated in the neighborhood of an interface between the fat and the alcohol mainly absorbs microwaves and is heated. As a result, reaction is accelerated, and microwave energy can be efficiently utilized for the reaction since it is not necessary to heat the whole mixed solution.

In the case where a solid catalyst, which tends to absorb microwaves, is selected as a catalyst, when micro-droplets of a catalyst-containing raw material fluid including an alcohol, which is present in fat, and the solid catalyst are irradiated with microwaves, the solid catalyst concentrated in the neighborhood of the interface between the fat and the alcohol mainly absorbs microwaves, and is heated. As a result, reaction is accelerated, and microwave energy can be efficiently utilized for the reaction since it is not necessary to heat the whole mixed solution. Also, the solid catalyst is easily separated, and can be reused, and the amount of waste can be reduced.

### REFERENCE SIGNS LIST

100: Microwave irradiation unit
101, 101a, 101b: Mixer
102: Reaction tube
103: Stub tuner
104: Movable short circuit plate
105a, 105b, 105d, 215b, 215c: Liquid feeding pump
108a, 108b: Temperature measuring unit
111: Fat
112: Methanol
115: Ionic liquid
116: Solid catalyst
130a, 230b: Raw material tank
130b: Chemical tank
130d: Product liquid tank
131a, 131b, 131d, 231b, 231c: Agitation device
140: Back pressure valve
145a, 145b, 145c: Valve
230c: Catalyst tank
300: Mixer
301: Introduction unit
302: Dispersion unit
303: Discharge unit
304, 305: Packing
306: Bolt
311: Inlet for fat
312: Inlet for catalyst-containing raw material fluid
501: Waveguide

1. A fuel synthesizing method comprising:
mixing an alcohol and a catalyst to prepare a catalyst-containing raw material fluid and then preparing a mixed solution by mixing the catalyst-containing raw material fluid and fat; and
irradiating the mixed solution with microwaves to synthesize a fatty acid ester in which the alcohol is bound with a fatty acid constituting the fat.

2. The fuel synthesizing method according to claim 1, wherein the mixed solution is obtained by dispersing liquid droplets of the catalyst-containing raw material fluid in the fat.

3. The fuel synthesizing method according to claim 2, wherein the catalyst is an ionic liquid.

4. The fuel synthesizing method according to claim 3, wherein a relative dielectric loss factor of the ionic liquid is higher than a relative dielectric loss factor of methanol.

5. The fuel synthesizing method according to claim 2, wherein the catalyst is a solid.

6. The fuel synthesizing method according to claim 2, wherein the mixed solution is irradiated with the microwaves after being pressurized to a standard atmospheric pressure or higher, and the temperature of the mixed solution is set at a standard boiling point or higher.

7. The fuel synthesizing method according to claim 2, wherein the mixed solution, which has been irradiated with the microwaves, is irradiated with the microwaves at least one more time.

8. The fuel synthesizing method according to claim 2, wherein the mixed solution is irradiated with the microwaves in a state that the introduction of the mixed solution is stopped and the mixed solution is retained, and then the mixed solution is irradiated with the microwaves again in a state that the mixed solution is replaced, the introduction of the mixed solution is stopped, and the mixed solution is retained.

9. A fuel synthesizing apparatus comprising:
a mixing unit configured to prepare a mixed solution by mixing fat and a catalyst-containing raw material fluid including an alcohol and a catalyst; and
a microwave irradiation unit configured to irradiate the mixed solution with microwaves,
wherein the microwave irradiation unit has a function of synthesizing a fatty acid ester in which the alcohol is bound with a fatty acid constituting the fat.

10. The fuel synthesizing apparatus according to claim 9, wherein the mixed solution is obtained by dispersing liquid droplets of the catalyst-containing raw material fluid in the fat.

11. The fuel synthesizing apparatus according to claim 10, further comprising a premixing unit configured to prepare the catalyst-containing raw material fluid by mixing the alcohol and the catalyst.

12. The fuel synthesizing apparatus according to claim 10, wherein the mixed solution in the microwave irradiation unit is capable of being pressurized.

13. The fuel synthesizing apparatus according to claim 10, further comprising a flow channel for circulating the mixed solution, which has passed through the microwave irradiation unit, to the microwave irradiation unit.

14. The fuel synthesizing apparatus according to claim 10, wherein the microwave irradiation unit irradiates the mixed solution, which is stopped being introduced and is retained, with microwaves.

15. The fuel synthesizing apparatus according to claim 9, further comprising a premixing unit configured to prepare the catalyst-containing raw material fluid by mixing the alcohol and the catalyst.

16. The fuel synthesizing apparatus according to claim 9, wherein the mixed solution in the microwave irradiation unit is capable of being pressurized.

17. The fuel synthesizing apparatus according to claim 9, further comprising a flow channel for circulating the mixed solution, which has passed through the microwave irradiation unit, to the microwave irradiation unit.

18. The fuel synthesizing apparatus according to claim 9, wherein the microwave irradiation unit irradiates the mixed solution, which is stopped being introduced and is retained, with microwaves.

19. The fuel synthesizing method according to claim 1, wherein the catalyst is an ionic liquid.

20. The fuel synthesizing method according to claim 19, wherein a relative dielectric loss factor of the ionic liquid is higher than a relative dielectric loss factor of methanol.

21. The fuel synthesizing method according to claim 1, wherein the catalyst is a solid.

22. The fuel synthesizing method according to claim 1, wherein the mixed solution is irradiated with the microwaves after being pressurized to a standard atmospheric pressure or higher, and the temperature of the mixed solution is set at a standard boiling point or higher.

23. The fuel synthesizing method according to claim 1, wherein the mixed solution, which has been irradiated with the microwaves, is irradiated with the microwaves at least one more time.

24. The fuel synthesizing method according to claim 1, wherein the mixed solution is irradiated with the microwaves in a state that the introduction of the mixed solution is stopped and the mixed solution is retained, and then the mixed solution is irradiated with the microwaves again in a state that the mixed solution is replaced, the introduction of the mixed solution is stopped, and the mixed solution is retained.
